(19) United States
(12) Patent Application Publication
(10) Pub. No.: US 2016/0206502 A1
(43) Pub. Date: Jul. 21, 2016

(54) STIMULATION AND TREATMENT DEVICE

(71) Applicant: NEVROFLEX AS, Lillesand (NO)

(72) Inventor: Peder Ragnvald KØLTZOW, Snarøya (NO)

(73) Assignee: NEVROFLEX AS, Lillesand (NO)

(21) Appl. No.: 14/917,242

(22) PCT Filed: Sep. 11, 2014
(86) PCT No.: PCT/NO2014/050167

§ 371 Date: Mar. 7, 2016

(30) Foreign Application Priority Data
Sep. 11, 2013 (NO) 20131229
Jul. 11, 2014 (NO) 20140881

(51) Int. Cl. A61H 23/02; A61H 23/04

(52) U.S. Cl. CPC A61H 23/02; A61H 23/04; A61H 2201/0214; A61H 2201/0242; A61H 2201/1664

(57) ABSTRACT

A stimulation and treatment device has a housing with a wide first end part and a narrow second end part. A transducer mounted inside the first end part generates linear motion in response to applied power, and a rounded protrusion extending from the first end part is mechanically connected to the transducer and moved such that the motion can be applied to a patient. A control module mounted inside the first end of the housing is configured to control the delivery of power to the electromechanical transducer. The first end part is substantially spheroidal, and the second end part is substantially cylindrical and extends from the substantially spheroidal first part at the opposite side from the movable rounded protrusion. The shape and distribution of weight results in a user friendly and ergonomically correct device that can be programmed or configured to be useable for a wide range of treatment procedures.

### CROSS-REFERENCE TO RELATED APPLICATION

This application is a U.S. National Stage patent application of PCT/NO2014/050167, filed on 11 Sep. 2014, which claims priority to Norwegian Application No. 20131229 filed on 11 Sep. 2013, and Norwegian Application No. 20140881 filed on 11 Jul. 2014, the entire contents of each one of which is incorporated herein by reference.

### FIELD OF THE INVENTION

The present invention relates to a device for stimulation or treatment of the human body, and in particular to a device for percussive stimulation or treatment of specific points of the human anatomy.

### BACKGROUND OF THE INVENTION

The human skin and underlying tissue contains numerous receptors which are sensitive to touch, pressure, stretching and temperature. These receptors are distributed over the whole area of the human body in different depths. The sensitive area is known as the “receptive field”, which exists in the skin and in the tissue below the skin, in the muscles, the sensory and motor nerves, nerve endings, in the wall of blood vessels, and surface membrane of the bone.

These receptors are, under different conditions, sensitive in a selective fashion to stimulation parameters of forces applied to them, such as the direction, the power (mostly activated by a gentle force), and the frequency. By selective (or tuned) activation, these receptors signal the perception of the stimulation to the central nervous system, initiating processes within the body, and causing a comfortable relaxing sensation.

Stimulation of these receptors, or nerve sections, through stimulation of the skin is also believed to influence on organs, hormones and the metabolism, directly or in combination, for example providing enhanced communication therebetween. For this use, the stimulation must be relatively robust and firm in order to reach the required depth.

Stimulation of the skin and the underlying tissue by massage is also important in the case of injury, to improve and rehabilitate damaged tissue. In many cases, the use of controlled movement of skin and tissue is needed, and therefore, the direction, force and frequency must be accurately adjustable, to have an influence on the tissue.

Stimulation methods are typically based on application of pressure to the surface of the skin by a therapist, through finger depression and motion, or by mechanical devices. However, the therapist cannot develop the required directional movement with great accuracy, or in a constant rhythm, and it is difficult for the therapist to maintain these movements for long periods of time, due to fatigue. The resulting stimulation effects are therefore short term. Additionally, the therapist will be able to access only a few receptors in each pressure application. Existing mechanical devices, such as massage products that will target and focus on muscle groups and larger tissue areas, are typically inadequate for the use described above.

Percussive stimulation devices developed for example for chiropractic treatment, are known in the art, but they are often limited in their functionality such that they do not lend themselves to any range of different therapeutic approaches and treatment of different areas of the body, they are uncomfortable to work with for the therapist, particularly over time, and they suffer from technical limitations that limit their durability and their ability to operate continuously over a prolonged period of time without malfunctioning.

A chiropractic adjustment tool described in U.S. Pat. No. 6,663,657, which is hereby incorporated by reference in its entirety, is illustrative both of the state of the art and its shortcomings. The publication describes a device which can deliver a single impact when energized. If the device had been configured to deliver strokes at a given frequency over time it would have been uncomfortable for the operator to use and sideways wobble would have been generated by the strokes as a result of the pistol grip which is outside the axis defined by the movable parts of the device.

US published patent application 2013/0138023, which is hereby incorporated by reference in its entirety, describes a device for massaging or treatment of the back and neck muscles of a patient. The publication describes how a variable voltage can be applied to a drive motor in order to linearily move a massaging finger with a variable frequency range. The shape and distribution of weight results in an unwieldy and impractical device for prolonged use at different positions and angles.

Therefore it is desirable to provide devices that are ergonomically correct and comfortable to use, that are able to reach different depths of the treated area of the body and target the desired receptors and nerve sections, and that are able to be operational for a prolonged period of time.

### BRIEF SUMMARY OF THE INVENTION

The present invention aims at providing devices where the ergonomical and functional issues described above are overcome or at least significantly reduced, and to provide enhanced functionality and applicability to a number of therapeutic programs and approaches, including self-treatment by the patient.

In a first embodiment, the invention provides a stimulation and treatment device having a housing with a wide first end part and a narrow second end part. A transducer is mounted inside the wide first end part of the housing and configured to generate linear motion in response to applied power. A control module mounted inside the narrow first end of the housing and configured to control the delivery of power to the electromechanical transducer. The control module may control delivery of power to the transducer such that the device can operate with the appropriate force and frequency.

A rounded protrusion extending from the first end part of the housing is mechanically connected to the transducer such that the rounded protrusion can be moved relatively to the housing when the transducer is operative.

The first end part of the device is substantially spheroidal, and the narrow second end part is substantially cylindrical and extends from the substantially spheroidal first part at the opposite side from the movable rounded protrusion. The transition from the wide first end to the narrow second end produces a middle part of the housing with a concave profile.

In some embodiments of the stimulation and treatment device, the side of the wide first end part from which the narrow second part extends, may constitute a gripping surface such that the narrow second part will extend between the thumb and the index finger of an operator when the device is in use.

According to one aspect of the invention, the stimulation and treatment device, the center of gravity is inside the substantially spheroidal first end part of the device and on or near the axis defined by the linear motion generated by the transducer. In this way the device is not subject to any substantial wobble in any other direction than along the axis defined by the linear motion generated by the transducer, which is also the direction of force applied by the operator of the device. The position of the center of gravity can be obtained through adaptation of the weight and relative position of the transducer, the control module, and the shape, length and material of the housing.

Various embodiments of stimulation and treatment devices consistent with the principles of the invention may include different types of transducers. In particular, the transducer may be a mechanical or electromechanical transducer chosen from the group consisting of: a solenoid, an electric motor, and a pneumatic transducer.

In embodiments where the transducer is a solenoid or an electric motor, the control module can be an electronic control module. This control module can be configured to deliver the necessary power in terms of voltage and frequency to obtain the desired movement of the solenoid.

In order to avoid overheating, it is desirable to dissipate the heat generated by the transducer (e.g. a solenoid). A solenoid positioned outside the hand of the operator, and perhaps even outside the housing itself, might be sufficiently cooled by the natural flow of air around the device. However, due to the inventive shape of the device and the position of the solenoid inside it, the problem of heat dissipation is part of the larger problem of providing a device with a shape, weight distribution and functionality in terms of movement described above. In some embodiments of the invention, a stimulation and treatment device is provided with a plurality of ventilation openings, a passage or channel allowing air to pass from at least one first ventilation opening, past the transducer and out of at least one second ventilation opening. An electric fan can be mounted in or adjacent to the channel or passage and configured to produce a flow of air in through the at least one first ventilation opening, through the channel or passage, and out through the at least one second ventilation opening. The channel or passage may be constituted by the internal surface of the housing, and the external surface of the transducer.

According to another embodiment of the invention, a stimulation and treatment device includes a housing, an electromagnetic transducer mounted inside the housing and configured to generate linear motion in response to applied electric power, an electronic control module mounted inside the housing and configured to control the delivery of electric power to the electromechanic transducer, a plurality of ventilation openings, a passage or channel allowing air to pass from at least one first ventilation opening, past the transducer and out of at least one second ventilation opening, and an electric fan mounted in or adjacent to the channel or passage and configured to produce a flow of air in through the at least one first ventilation opening, through the channel or passage, and out through the at least one second ventilation opening.

### BRIEF DESCRIPTION OF THE DRAWINGS

For a better understanding of the invention, a detailed description of various embodiments and aspects will now be presented with reference to the attached drawings, in which like numerals designate corresponding elements or sections of the device embodiments, and in which:

FIG. 1 is a perspective view of a stimulation and treatment device consistent with certain aspects of the invention;

FIG. 2 is a perspective view of a stimulation and treatment device illustrating certain alternative aspects of the invention;

FIG. 3 is a side view showing an example of an internal assembly arranged inside the device; and

FIG. 4 is a bottom view of a device consistent with the principles of the invention.

### DETAILED DESCRIPTION OF THE INVENTION

In the following description of various embodiments it should be noted that, unless otherwise stated, different aspects can be freely combined with each other whether or not they have been described together with reference the same embodiment below. The combination of features and aspects in the exemplary embodiments are done in order to facilitate understanding of the invention rather than limit its scope to a limited set of embodiments. Furthermore, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention.

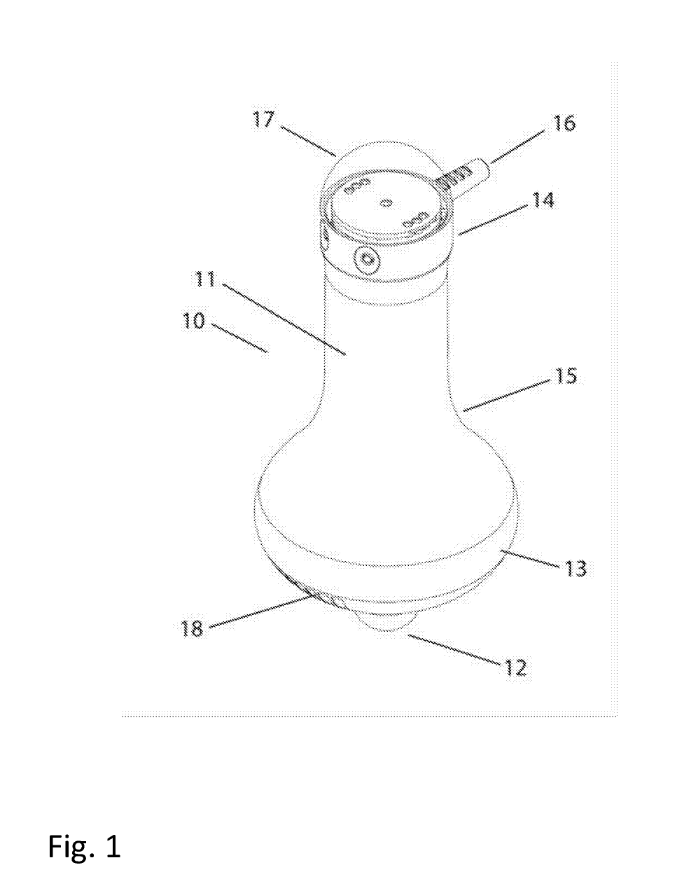

Reference is first made to FIG. 1, which is a perspective view of a device 10 for stimulation or treatment of the human body. The device 10 comprises a housing 11 which encloses an assembly which constitutes a majority of the movable parts generating the stimulation motion and force that is applied to the treated area of the body, as well as electrical and electronic components for energizing and controlling this motion. The internal assembly will be described in further detail below.

A rounded protrusion 12 is extending from a first end part or portion or section 13 of the housing 11. The rounded protrusion 12 is mechanically connected to a transducer which is part of the internal assembly and will be described in further detail below. The rounded protrusion 12 can be moved relative to the housing by the transducer, and the motion can be applied to the body of a patient during treatment.

The housing 11 shown in FIG. 1 is elongated, concentric and rounded in both end parts 13, 14. The diameter is larger at the first end part 13 and more narrow at the second end part or portion or section 14, and the change in diameter of the overall shape of the housing 11 follows a concave profile such that the diameter increases more rapidly closer to the first end, giving the device a pear-shape or gourd-shape. The shape can also be described as having a first end part 13 which is substantially spheroid and a narrow second end part 14 which is substantially cylindrical. The second end part 14 extends from the wider first end part 13 at the opposite side from the rounded protrusion 12, and the transition from the wide first end to the narrow second end part produces a middle part (or portion or section) 15 with a concave profile.

This shape allows an operator to hold the device 10 in one hand with the palm enclosing or resting against the surface of the middle part 15 of the housing that deviates most from being parallel to the direction of motion of the protrusion 12 (where the first end part 13 ends and the middle part 15 begins), facilitating application of force by the operator while at the same time providing a comfortable grip and maneuverability with respect to the direction of the device 10 against the treated area of the patient's body.

While held in this manner the second end part 14 extends backwards between the thumb and the index finger of the operator and, in embodiments where the second end part 14 does not extend too far or contain too many heavy parts, the device will be well balanced and the center of gravity remains inside the operators grip. By distributing weight around the axis defined by the motion generated by the transducer, and by using a transducer which itself has its center of gravity in or near this axis, the center of gravity will, in addition to being inside the operators grip, be on or near the axis of motion, which is also coaxial with the direction of force applied by the operator. Consequently, essentially all force applied by the various components of the device and by the operator will be in one direction, and there will be no wobble or drift in any other direction. This is an aspect of the invention which facilitates accuracy of applied strokes and force, as well as ergonomy and comfort for the operator.

When the first end part 13 is referred to as being substantially spheroidal, this should be understood as having a shape that has a spheroidal appearance to an observer, without any significant observable deviation from a spheroidal shape, except from in the transitional middle part area. However, any egg shaped form and any deviation from a purely spheroidal shape which is inside 20%, for example a deviation of about 10%, should in any case be considered to be substantially spheroidal in the context of the invention. Similarly, substantially cylindrical should be understood as having a shape that has a circular or oval cross-section and with parallel sides, although the sides may taper towards the end or, alternatively be more narrow in the concave transitional area. Also the center of the substantially cylindrical end part 14 does not have to be a straight line. For example, the substantially cylindrical end part 14 may equally well be curved.

The shapes referred to is also only intended to describe the overall shape, and not any local ribs, ridges, grooves, slits or other shapes intended to facilitate or provide a better or more comfortable grip, higher friction against the hand of the operator, the presence of control buttons, holes or vents etc.

The second end part 14 of the device 10 may comprise a display element 17. The display element 17 may show information relating to the operating mode of the device and considered useful for the operator, such as stroke length of the rounded protrusion 12, force, frequency of the applied strokes, time the device has been in use, etc. The information displayed by the display element 17 may be controlled by an electronic control module, as described further below. The display element 17 in this embodiment includes indicators that indicate power on and mode of operation in the form of lights that are on, off, or a particular color.

The second end part 14 may further be adapted for manual stimulation. By turning the device around, placing the second end 18 of the device on the patient in the area of the body to be stimulated, and then moving or pressing the device towards the patient, the operator can stimulate or massage the patient manually, or locate nerve endings or other points that should be subject to treatment. In order to facilitate this the second end 18 may be rounded or at least without any sharp edges. The material of the upper end of the housing may be different from the material of the rounded protrusion, for example it may be of a material or with a surface texture with lower friction against human skin. The material may also be transparent in order to provide a view of the display element 17.

In use, the rounded protrusion 12 is positioned on the skin of a patient and the operator grips the housing 11 with his/her hand and presses the device against the patient's body with a force suitable for reaching the receptors at that position and obtain the desired effect. The particular effect desired in a specific situation will depend on the patient, the area of the body to be treated, which receptive fields or trigger points it is desirable to reach, and the type of treatment or stimulation method that is applied. Various embodiments of the invention may be specifically adapted to or programmable to be used in accordance with modern as well as alternative and traditional treatment and does not concern itself with the relative efficiency of a particular type of treatment.

The stimulation device illustrated in FIG. 1 further comprises a connection for electric power in the form of a power cable 16 (only the beginning of which is illustrated in the drawing). As an alternative to power cord connection the device may include batteries, for example a rechargeable nickel-cadmium (NiCd), nickel-metal hydride (NiMH) or lithium-ion (Li-ion) battery. When designing an embodiment with batteries the designer would have to take into consideration the weight of the battery, the desired force and frequency of the strokes delivered by the device and desired duration of operation. The specific characteristics of the unit used to convert electrical power to motion in the internal assembly of the device 10 as well as the heat generated by the battery during discharge may also be factors that will have to be taken into consideration. The characteristics of available batteries, both with respect to type and voltage, are well known and a particular choice must be left as a design choice depending on the desired combination of features and capabilities of a specific embodiment.

The surface of the device 10 may also include openings 19 for ventilation allowing heat generated by the internal assembly to escape. In the embodiment illustrated in FIG. 1 such openings 19 are shown near the first end 13 of the device 10 where the surface begins to curve back towards the center axis of the device 10 (the bottom of the gourd-shape). This placement ensures that the openings will not be covered by the hand of the operator during operation. However, depending on the softness of the tissue treated and the depth of the stimulated point in the patient's body, there is a risk that the openings 19 may be resting against the skin of the patient and thereby be partially or fully blocked. This will be discussed in further detail below.

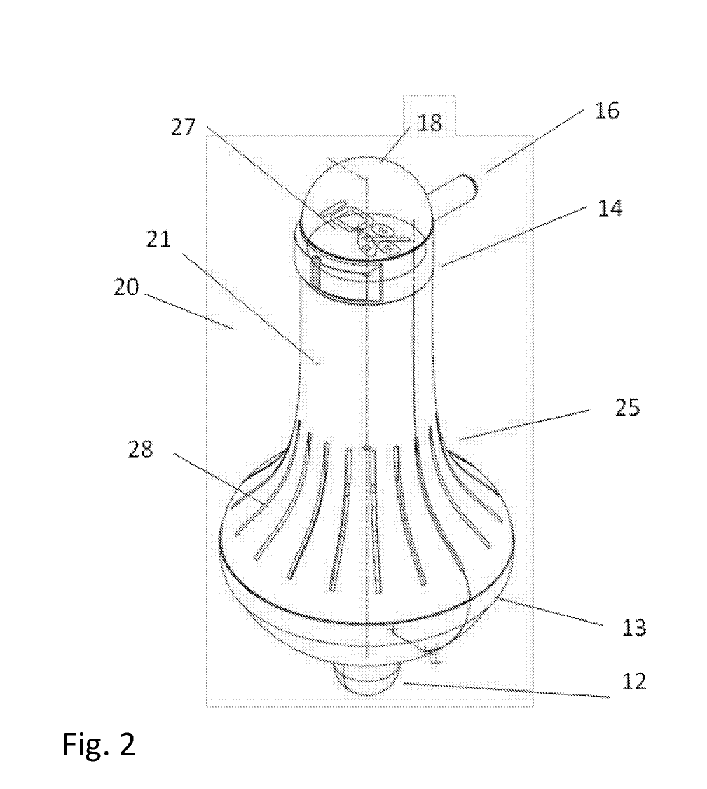

FIG. 2 shows a perspective view of a stimulation device 20 for stimulating skin and underlying tissue. The stimulation device 20 is similar to the stimulation device shown in FIG. 1 and comprises an ergonomically shaped housing 21 and a movable rounded protrusion 12 arranged in a lower end 13 of the housing 21. The rounded protrusion 12 is connected to an internal assembly arranged within the housing 21. The internal assembly will be described in further detail below.

The housing 21 illustrated in FIG. 2 has the same elongated, concentric shape and is concentric in both end parts 13, 14, with the diameter in the lower end part 13 being larger than in the upper end part 14, and increasing more rapidly towards the first end, giving the housing 21 a pear or gourd-like shape.

This embodiment is illustrated with a display element 27 at the rounded second end 18 showing the number 10%, which for example may indicate that the device is working at 10% of maximum power. Other information may also be shown, such as stroke length of the rounded protrusion 12, force used on the patient, frequency of the applied strokes, time the device has been used, etc. The rounded second end 14 may further be adapted for manual stimulation, by turning the device around, as described with reference to FIG. 1.

The housing 21 has in this embodiment, in the middle section 15 where an operator will rest the palm of his hand, a number of ribs 28 which are arranged to provide friction and thus a better grip when an operator uses the stimulation device. The ribs 28 may for example be made of rubber, silicone or other material which enhances the grip of the hands, or they may simply be protruding from the surface of the housing 21. Other textures or materials that may increase the friction and improve the grip may also be chosen. Instead of ribs 28, the housing may also be provided with grooves, slits or openings in the middle section.

The stimulation device shown in FIG. 2 is illustrated with a similar power cord connection 16 as the one shown in FIG. 1, and the same applies with respect to the alternative of using batteries.

The various features illustrated in FIG. 1 and FIG. 2, respectively, are not mutually exclusive. Instead they may be freely combined, for example in that the display unit 17 may be combined with the ribs on the middle section of housing 21, and even in a display unit with both the indicator lights of display unit 17 and the alphanumerical or graphical display showing number (or other information) in display unit 27.

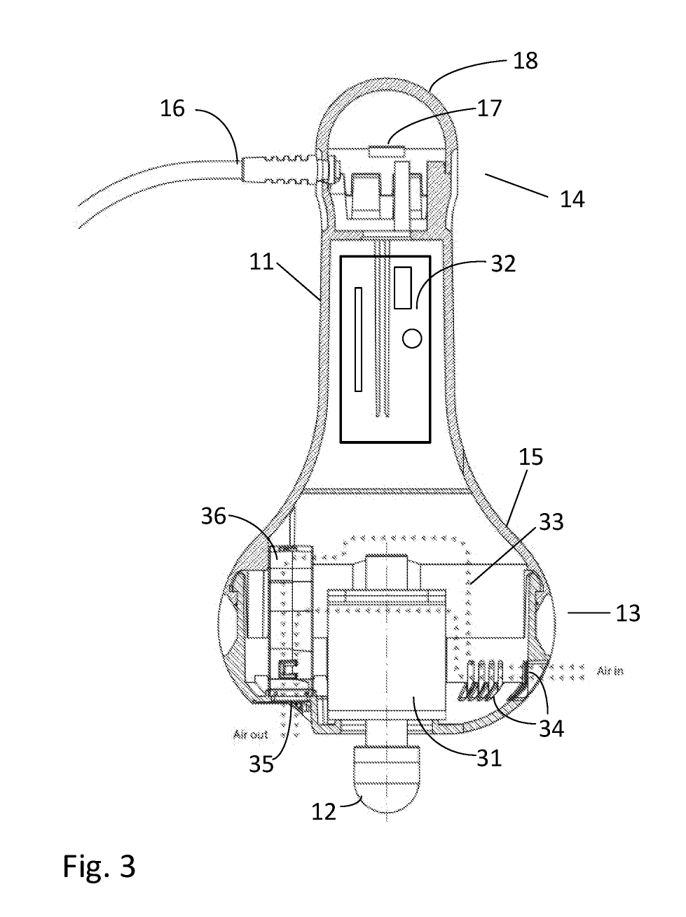

Turning now to FIG. 3, which shows a first view of an exemplary embodiment of the internal assembly, the functionality of the device when it is energized will be explained.

At the heart of the device is a motor, or transducer. Generally speaking a transducer is a device that converts a signal in one form of energy to another form of energy. In the present description the transducer converts supplied energy into linear motion. In the embodiment illustrated in FIG. 3 the motor is an electromagnetic solenoid 31, but other alternatives are consistent with the principles of the invention, including, for example, a rotary electric motor combined with an assembly for converting rotary to linear motion, or a pneumatic actuator which produces the desired linear motion when provided with air with the appropriate pressure.

The solenoid 31 illustrated in FIG. 3 comprises an electromagnetically inductive coil wound around a movable armature of a magnetic material such as steel or iron. The coil is shaped such that the armature can be moved in and out of the center, altering the coil's inductance and thereby becoming an electromagnet. The control of the current fed to the inductive coil will control the magnetic field and thus the movement of the armature within the coil. The solenoid 31 may be controlled directly by a controller circuit 32, and thus have very short reaction times.

The force applied to the armature is proportional to the change in inductance of the coil with respect to the change in position of the armature, and the current flowing through the coil (Faraday's law of induction). The force applied to the armature will always move the armature in a direction that increases the coil's inductance.

The solenoid 31 may be configured to move the rounded protrusion 12 backwards, away from the patient when power is applied, such that a spring (not shown) is loaded. When the power is no longer applied the spring will release its power and the rounded protrusion 12 will be moved towards the patient by the spring, delivering a stroke. Alternatively, application of power may move the armature, and thereby the rounded protrusion 12, directly toward the patient, and a return spring may return it to its original position when the power is released.

An example of the former is ZHM-1445S Massager Solenoid, which is produced by Zonhen Electric Appliances of China. A data sheet published by Zonhen describes various parameters such as stroke length vs force at various combinations of frequency and power, and ampere-turns vs force at different stroke lengths. This can be used by a designer to configure the electronic control circuit 32 to deliver the necessary power relevant for a given procedure or protocol of treatment. This solenoid has a total weight of 380 g, which can be taken into consideration when designing for distribution of weight. The data sheet is hereby incorporated by reference.

It will be realized that while a solenoid inherently is somewhat elastic since the armature does not have to complete motion in a first direction before it begins moving in the opposite direction, this is not the case with a rotary electric motor unless additional components introduce such elasticity. Pneumatic actuators may be constructed such that the elasticity inherent in the compression and decompression of air is exploited, or they may be constructed such that complete movement in one direction is necessary to release air pressure before a new cycle begins. This elasticity, or damping, may be desirable in various applications because it may reduce discomfort for the operator as well as the patient when the rounded protrusion 12 hits harder tissue or bone.

The rounded protrusion 12 is in this exemplary embodiment connected to the armature. Alternatively it can be a part of the armature or it can be integrated in the armature. The rounded protrusion 12 will thus move when the armature is moved in and out of the coil. In use, an operator will position the rounded protrusion 12 on the section of the body that is to be stimulated, either directly on the skin, or on clothes or other appropriate cover. The hands of the operator will hold the housing and press the rounded protrusion 12 toward the skin of the patient with an appropriate force and angle. In this way the operator can use his/her experience and knowledge to decide the force and direction of the stimulation, while the stimulation device provides additional stimulation, by the movement of the rounded protrusion. The stimulation device may be used without the additional stimulation, by not turning on the current fed to the inductive coil.

In one embodiment the rounded protrusion 12 has a diameter of 2.5 cm, but other dimensions are consistent with the principles of the invention, for example anywhere within the range from 1 to 4 cm. The surface area of the part of the device which is in contact with the patient will then be approximately about 20 mm in diameter or greater, as determined by the size and shape of the rounded protrusion 12. This size may vary depending on the pressure applied manually by the operator, and in some embodiments of the invention additional variation may be obtained with different, replaceable operational units or heads which can be attached and detached according to need. At the very least varying diameters from 1 centimeter to 4 centimeters can be contemplated.

In one embodiment, the maximum vertical displacement or displacement range (i.e., total vertical travel from extended position to retracted position) of the operational portion of the device, ie. the rounded protrusion 12, is about 10 mm, which may also be referred to as the stroke length of the device. In some embodiments the stroke length may be variable from about 0.5 mm to 10 mm. The operational force or hardness of the device is configured from 0% to 100%, with the maximum of at about 5 kgf. In addition, in operation there the device may be operated at speed or frequency of the operational portion of about 1 to 10 or greater beats/second.

The various modes of operation with respect to stroke length (displacement), operational force and frequency may in some embodiments be controlled by way of an electronic circuit 32 which is supplied with electrical energy and which can be programmed to deliver an alternating voltage to the coil of the solenoid 31. The amplitude, shape and frequency of the voltage will determine the stroke length, force and frequency with which the rounded protrusion 12 stimulates the area to be treated. The electronic circuit must be designed in accordance with the capabilities of the chosen solenoid and the requirements of the treatment for which a particular embodiment is designed to be used.

The electronic module 32 can be implemented in a number of ways which will be known to a person skilled in the art, ranging from analog oscillating circuits, use of timer circuits (such as the well known 555 timer), through use of programmable or pre programmed circuits such as EEPROMs, AISCs etc. The user interface may be constituted by buttons on the surface of the device or on a control unit (not shown) which is provided remotely and for example connected to the device over wires integrated in the power cable 16. It is also conceivable to provide a wireless interface using Bluetooth, Zigbee or some other standard protocol known in the art, and the user interface may then be provided on a separate device or in the form of an app running on a general purpose device such as a smart phone. The characteristics (pulse shape, amplitude and frequency) of the power delivered from the electronic module 32 to the solenoid 31 is dictated by the characteristics of the chosen solenoid 31 and the requirements of the programs it is desirable to be able to run on a particular embodiment. The electronic module may be connected to the display unit 17 (or 27 in FIG. 2) which may provide information regarding settings and operating status of the device to the operator, as explained above.

The device may further comprise an air channel 33 adjacent to the solenoid 31 inside the housing 11 in order to provide cooling of the solenoid 31. The air channel 33 is arranged in heat exchanging contact with or a heat exchanging distance from the solenoid. The air channel 33 is illustrated in FIG. 3 only as in indication of how the air may flow. The air channel may typically be constituted by various internal surfaces of the housing 11, including additional internal protrusions, ridges and profiles directing the flow of air, as well as the outer surfaces of the solenoid 31. The air channel 33 may therefore not necessarily be a separate component, but rather a result of a design that deliberately avoids obstruction of air flow between an intake vent 34 and an outlet vent 35 in the housing 11. There may further be arranged a fan 36 in or near the air channel for providing airflow through the air channel 33 for further improvement of the cooling effect.

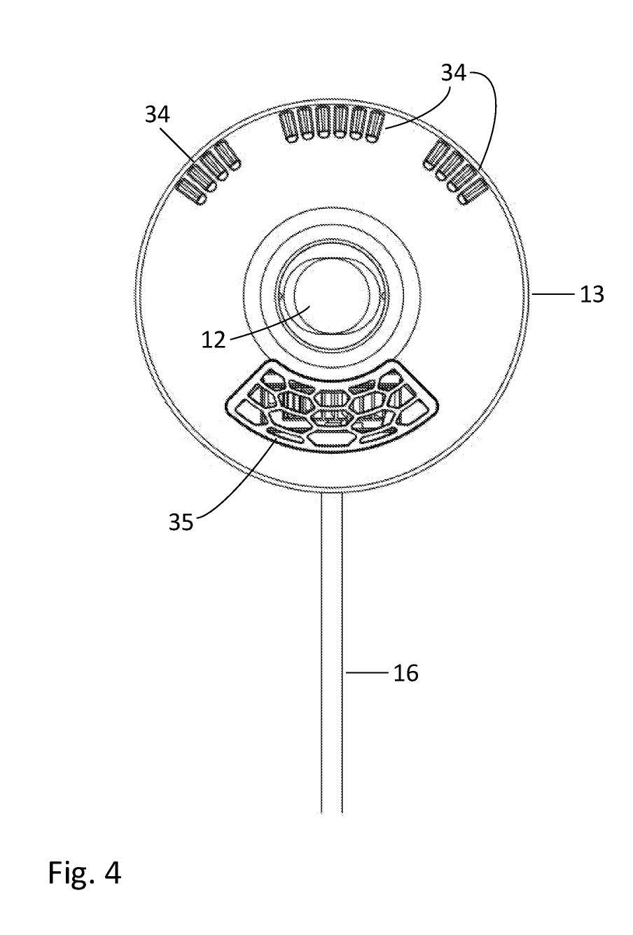

FIG. 4 provides a bottom view of the device showing the relative positions of intake vents 34 and outlet vent 35. The view is from the first end of the device, showing the first end part 13, which hides other parts and components from view, except from the power cable 16. The fan is positioned immediately behind the outlet vent 35 as seen in this view.

In some embodiments the fan is RLF35-8/12/2HP-113, produced by ebm-pabst of Germany, a blower type fan which takes air in axially and blows air out radially. A datasheet published by ebm-pabst is hereby incorporated by reference in its entirety.

The additional components and parts shown in FIG. 3 correspond to those shown in FIG. 1 and include the housing 11 itself with its first end part 13, second end part 14 and middle part 15. It can be seen from this drawing how the rounded end part 18, if made from a transparent material, will provide a view of the display 17 (or 27).

The unit may be configured with pre-programmed operational settings including time of use and hardness settings for treatment of specific parts of the body. In some embodiments the device may be provided with e.g. a Bluetooth receiver (not shown) in order to facilitate wireless selection of programs or adjustment of the various settings with an external device, e.g., a mobile device such as a smartphone, a tablet and the like. The desired treatments may vary from one patient to another, and may depend on muscle mass, individual tolerance and the illness, injury or ailment to be treated. For example, for regular treatments of points rate may be 10 strokes/second, and from 3 degrees of hardness—hardness 30%—hardness 60% and hardness 90% of maximum hardness (Maximum hardness may be approximately 4 to 5 kg).

Some other examples of hardness settings may be upper body hardness 30%, arms hardness 60%, hips hardness 60%-90%, thigh hardness 90%, and feet and hands hardness 30%. It should be noted that the specific hardness required, as well as the frequency of the strokes, the duration of application as well as the number of repetitions and the length of any pause between repetitions is dependent on the specific treatment or program the operator wants to apply to the patient, and that the program itself or its effectiveness on the patient is not part of the invention as such. Rather, the invention is the provision of an apparatus that the operator, whether that is a health care provider, other practitioner or the patient him- or herself, can program and use in accordance with what the specific treatment requires.

It is again emphasized that the requirements of the particular method, procedure, protocol or philosophy upon which a given treatment is based is not part of the invention as such. Numerous alternatives exist within the schools of modern medicine, alternative medicine as well as traditional (or folk) medicine, and range from treatment of diagnosed illnesses and ailments, through massage, to treatment intended to create relaxation or a feeling of well-being, and embodiments of the invention can be configured to be adjustable or specifically designed for any of these.

In one embodiment the stimulation device further comprises a display element arranged in the second end 14 of the device 10 and connected to the processing unit for displaying signals received from the processing unit.

1. A stimulation and treatment device comprising:
a housing with a wide first end part and a narrow second end part;
a transducer mounted inside said wide first end part of said housing and configured to generate linear motion in response to applied power;
a control module mounted inside said narrow first end of said housing and configured to control the delivery of power to said electromechanical transducer; and
a rounded protrusion extending from the first end part of said housing and mechanically connected to said transducer;
wherein said wide first end part is substantially spheroidal, and said narrow second end part is substantially cylindrical and extends from the substantially spheroidal first part at the opposite side from the movable rounded protrusion; and
wherein the transition from the wide first end part to the narrow second end part produces a middle part of the housing with a concave profile.

2. A stimulation and treatment device according to claim 1, wherein the side of the wide first end part from which the narrow second part extends constitutes a gripping surface such that said narrow second part will extend between the thumb and the index finger of an operator when the device is in use.

3. A stimulation and treatment device according to claim 1, wherein the center of gravity is inside said substantially spheroidal first end part of said device and on or near the axis defined by the linear motion generated by said transducer.

4. A stimulation and treatment device according to claim 3, wherein the position of the center of gravity is obtained through adaptation of the weight and relative position of said transducer, said control module, and the shape, length and material of said housing.

5. A stimulation and treatment device according to claim 1, wherein said transducer is a mechanical or electromechanical transducer chosen from the group consisting of: a solenoid, an electric motor, and a pneumatic transducer.

6. A stimulation and treatment device according to claim 5, wherein said transducer is a solenoid or an electric motor and said control module is an electronic control module.

7. A stimulation and treatment device according to claim 1, further comprising:
a plurality of ventilation openings;
a passage or channel allowing air to pass from at least one first ventilation opening, past said transducer and out of at least one second ventilation opening; and
an electric fan mounted in or adjacent to said channel or passage and configured to produce a flow of air in through said at least one first ventilation opening, through said channel or passage, and out through said at least one second ventilation opening.

8. A stimulation and treatment device according to claim 7, wherein said channel or passage is constituted by the internal surface of said housing and the external surface of said transducer.

9. A stimulation and treatment device comprising:
a housing;
an electromagnetic transducer mounted inside said housing and configured to generate linear motion in response to applied electric power;
an electronic control module mounted inside said housing and configured to control the delivery of electric power to said electromagnetic transducer;
a plurality of ventilation openings;
a passage or channel allowing air to pass from at least one first ventilation opening, past said transducer and out of at least one second ventilation opening; and
an electric fan mounted in or adjacent to said channel or passage and configured to produce a flow of air in through said at least one first ventilation opening, through said channel or passage, and out through said at least one second ventilation opening.
